(19) United States
(12) Patent Application Publication
(10) Pub. No.: US 2012/0233355 A1
(43) Pub. Date: Sep. 13, 2012

(54) CONTAINER DATA CENTER

(75) Inventor: YI-LIANG HSIAO, Tu-Cheng (TW)

(73) Assignee: HON HAI PRECISION INDUSTRY CO., LTD., New Taipei (TW)

(21) Appl. No.: 13/086,407

(22) Filed: Apr. 14, 2011

(30) Foreign Application Priority Data
Mar. 9, 2011 (TW) 100107981

(51) Int. Cl. G06F 15/16

(52) U.S. Cl. 709/250

(57) ABSTRACT

A container data center includes a container, a number of servers, and a network hub. The servers are stacked in the container. Each server includes a network connector. The network hub is received in the container, and arranged to one side of the servers. The network hub includes a number of network interfaces. Each network interface aligns with the network connector of the corresponding server.

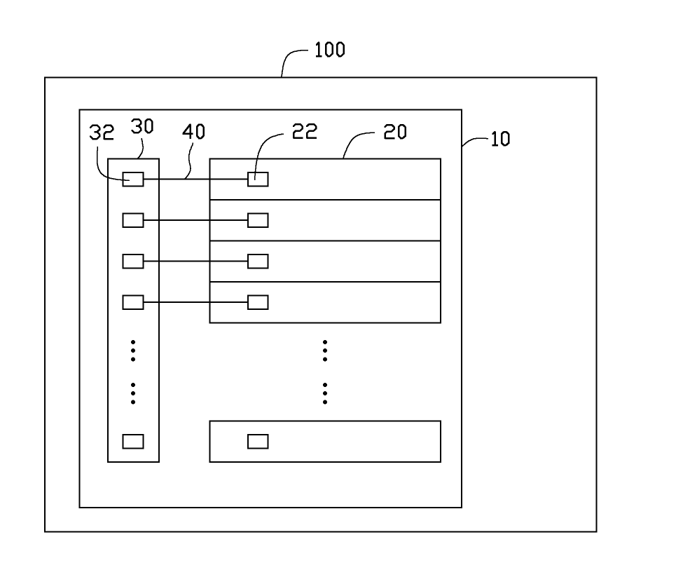

### BACKGROUND

1. Technical Field

The present disclosure relates to a container data center.

2. Description of Related Art

Presently, many network hubs of a container data center are mounted on top of corresponding servers of the container data center. Network interfaces of the network hub are connected to network sockets of the servers through many network cables. The network cables are connected and often tangled together at one side of the servers, and are thus messy and inconvenient to deal with.

### BRIEF DESCRIPTION OF THE DRAWING

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

The drawing is a schematic view of an exemplary embodiment of a container data center.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the drawing, an exemplary embodiment of a container data center 100 includes a container 10, a plurality of servers 20, and a network hub 30. The servers 20 are arranged in a single stack in the container 10. The network hub 30 is received in the container 10, and stands to one side of the servers 20.

Each server 20 includes a network connector 22 arranged near the network hub 30.

The network hub 30 is substantially rectangular, and includes a plurality vertically arranged network interfaces 32. Each network interface 32 horizontally aligns with one of the network connectors 22 to minimize a distance between each network interface 32 and the corresponding network connector 22. Therefore, it is convenient to use network cables 40 to connect the network interfaces 32 to the corresponding network connectors 22.

When the container data center 100 needs to communicate with a network, the network connector 22 of each server 20 is connected to the corresponding network interface 32 of the network hub 30 with one of the network cables 40.

In other embodiments, the number of the network interfaces 32 of the network hub 30 can be changed as needed to accommodate any number of the servers 20.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A container data center comprising:
a container;
a plurality of servers arranged in a single stack in the container, wherein each server comprises a network connector; and
a network hub received in the container, and arranged to one side of the plurality of servers, wherein the network hub comprises a plurality of network interfaces, each network interface aligns with the network connector of a corresponding server.

2. The container data center of claim 1, wherein the network hub is substantially rectangular, the plurality of the network interfaces is vertically arranged on the network hub.

3. The container data center of claim 1, wherein each network interface horizontally aligns with the network connector of a corresponding one of the plurality of servers.
